(19) United States
(12) Patent Application Publication
(10) Pub. No.: US 2017/0101284 A1
(43) Pub. Date: Apr. 13, 2017

(54) PRINTING SYSTEM WITH SHEET INSERTER

(71) Applicant: OCÉ-TECHNOLOGIES B.V., Venlo (NL)

(72) Inventor: Vinod MENEZES, Venlo (NL)

(73) Assignee: OCÉ-TECHNOLOGIES B.V., Venlo (NL)

(21) Appl. No.: 14/877,251

(22) Filed: Oct. 7, 2015

(51) Int. Cl. B65H 39/06; B65H 5/26; B65H 31/00; B41J 13/10

(52) U.S. Cl. CPC B65H 39/06; B41J 13/103; B65H 5/26; B65H 31/00; B65H 2301/421; B65H 2301/433

(57) ABSTRACT

A printing system includes at least one main printer arranged to print images onto main sequence sheets that are passed sequentially through the main printer; an inserter arranged to insert individual sheets as insert sheets into a stream of main sequence sheets that have left the main printer, thereby to form a mixed sheet sequence; and a conveyer arranged to convey the sheets of the mixed sheet sequence one by one towards an output unit. An insert sheet printer is connected to the inserter for printing the insert sheets and forwarding them to the inserter.

The invention relates to a printing system comprising:
at least one main printer arranged to print images onto main sequence sheets that are passed sequentially through the main printer;
an inserter arranged to insert individual sheets as insert sheets into a stream of main sequence sheets that have left the main printer, thereby to form a mixed sheet sequence; and
a conveyer arranged to convey the sheets of the mixed sheet sequence one by one towards an output unit.

In such a printing system, the inserter is used for inserting special sheets (insert sheets) which cannot be printed with the main printer into the sequence of sheets that are forwarded to the output unit where the sheets are stacked on an output tray or are processed further in a finisher. For example, when the main printer is a high production black/white printer, and the specifications of a print job require that a colour image is to be printed onto a specific sheet, e.g. a cover sheet, the inserter is used for inserting the cover sheet which has been printed on a separate colour printer. As another example, the inserter may be used for inserting sheets of a media type that cannot be processed in the main printer or should not be processed on the main printer because that would slow down in a main printer and thereby compromise the productivity (e.g. because the settings of the main printer would have to be adapted to the specific media type).

An example of a printing system of this type has been described in U.S. Pat. No. 5,272,511. In the known system, the inserter has a feed tray where the insert sheets that have been printed on a separate printer can be placed manually by the operator so that they will be drawn-in by the inserter and inserted into the stream of main sequence sheets at the correct timings.

It is an object of the invention to provide a printing system of this type which is more comfortable to operate.

According to the invention, in order to achieve this object, an insert sheet printer is connected to the inserter for printing the insert sheets and forwarding them to the inserter.

In this system, the insert sheets can be printed when they are required for the print job by means of the insert sheet printer and can be fed to the inserter automatically, so that the operator is relieved from the burden of fetching the printed insert sheets from the separate printer and placing them onto the feed tray of the inserter.

Since, in a typical print job, the number of insert sheets will be significantly smaller than the number of main sequence sheets, the insert sheet printer may be a low-cost low production printer, e.g. a small house-hold printer.

More specific optional features of the invention are specified in the dependent claims.

The insert sheet printer may be arranged to supply the printed insert sheets onto a feed tray of the inserter. This has the advantage that the inserter may be of a conventional design having a feed tray which has heretofore been used for supplying the sheets manually. Another advantage is that the feed tray of the inserter may serve as a buffer, so that the insert sheets may be printed in advance and may be held ready until they are needed by the inserter.

The insert sheet printer may be a duplex printer.

In a preferred embodiment, a common control system is provided for controlling the main printer, the insert sheet printer and the inserter in accordance with the specifications of the respective print jobs.

Embodiment examples will now be described in conjunction with the drawings, wherein:

FIG. 1 is a schematic view of a printing system according to the invention,

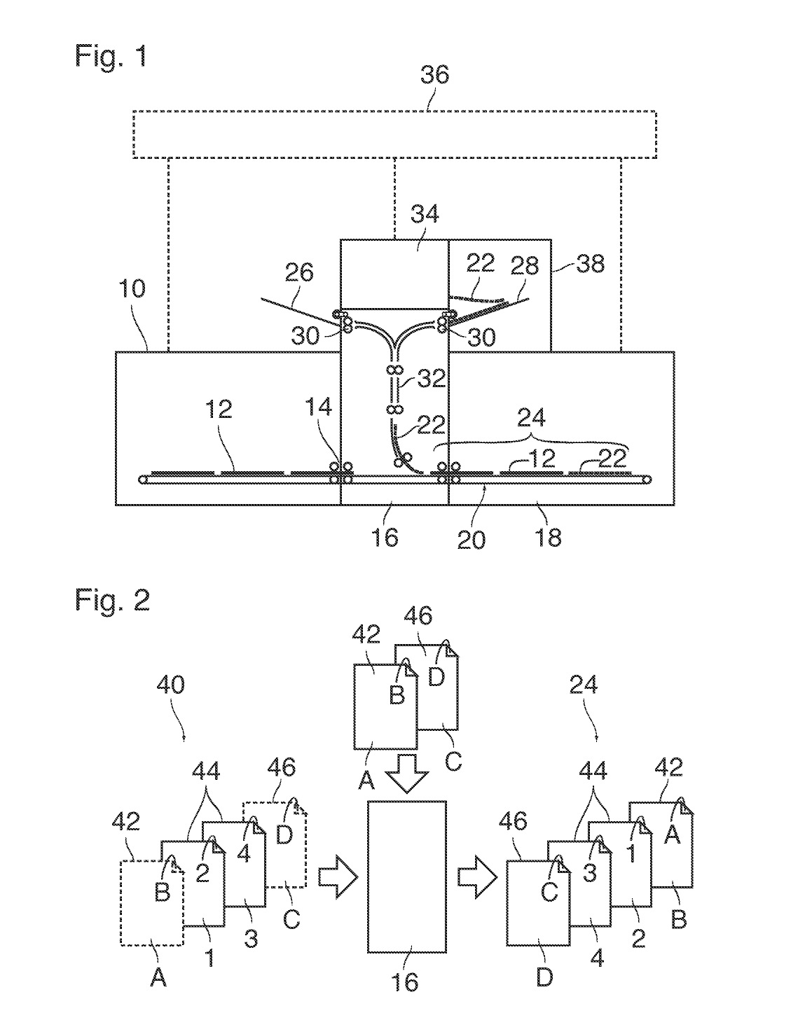

FIG. 2 illustrates a first example of a printing scheme according to which sheets are printed in the printing system shown in FIG. 1;

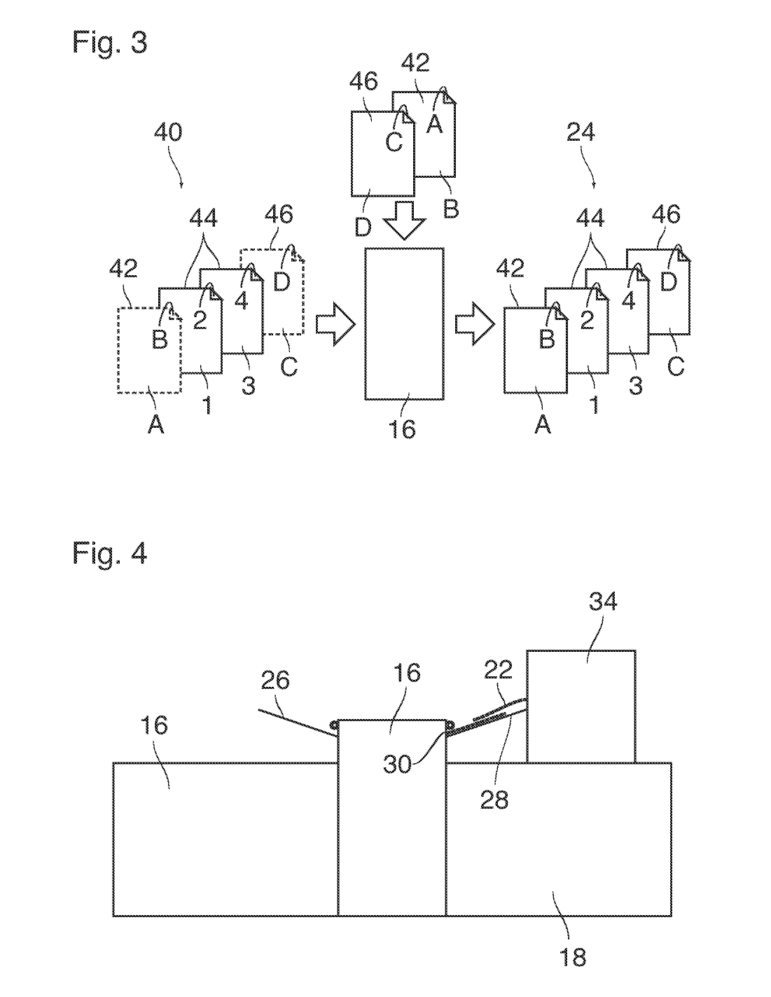

FIG. 3 shows another example of a printing scheme; and

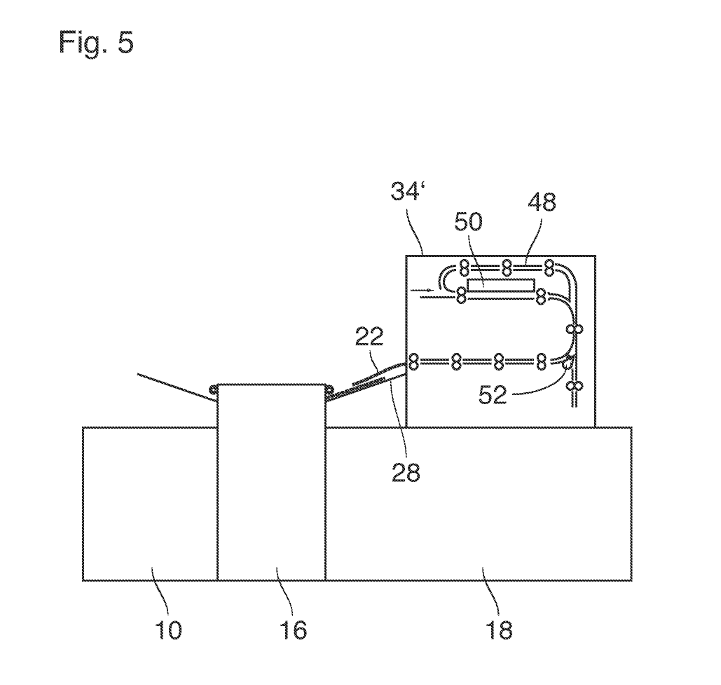

FIGS. 4 and 5 are schematic views of modified embodiments of a printing system according to the invention.

The printing system shown in FIG. 1 comprises a high production main printer 10 arranged to print images onto main sequence sheets 12 which will then be discharged one by one at an outlet port 14 of the main printer.

The printing system further comprises an inserter 16 disposed adjacent to the main printer 10 and arranged to receive the main sequence sheets 12 from the main printer and forwarding them to an output unit 18 which may comprise one or more finishers, for example.

A conveyer 20 is provided for conveying the sheets sequentially from the main printer 10 through the inserter 16 to the output unit 18. Consequently, the conveyer 20 has an upstream section within the main printer 10, an intermediate section within the inserter 16, and an output section within the output unit 18.

The inserter 16 is arranged to convey insert sheets 22 towards the intermediate section of the conveyer 20 so that they are inserted into the stream of main sequence sheets 12 arriving from the main printer 10, thereby to form a mixed sheet sequence 24 composed main sequence sheets 12 and insert sheets 22 which are forwarded one after the other towards the output unit 18.

The inserter 16 may have a conventional design. In the example shown, it comprises first and second feed trays 26, 28 and respective sheet feeders 30 arranged to withdraw insert sheets from the trays 26, 28 and to forward them onto the conveyer 20 via a sheet transport line 32.

In a conventional printing system, the insert sheets 22 would have been placed manually onto one of the trays 26, 28. However, in the printing system that is proposed here, an insert sheet printer 34 is placed on top of the inserter 16 and arranged to print images on one or both sides of each insert sheet and to discharge the printed insert sheet onto the feed tray 28 of the inserter. Thus, only the tray 26 is used as a manual feed tray, whereas the tray 28 is used for receiving the insert sheets that have been printed in the insert sheet printer 34. For example, the insert sheet printer 34 may be a low production colour printer when the high production main printer 10 is a black and white printer.

An electronic control system 36 is provided for controlling all the components of the printing system, i.e., the main printer 10, the inserter 16, the insert sheet printer 34 and, if necessary, the output unit 18.

When a new print job is submitted, the control system 36 analyses the job specifications and schedules the sheets for printing. When the job specifications prescribe that certain sheets within the job are to receive a colour image, these sheets are scheduled for being printed as insert sheets 22 with the insert sheet printer 34, whereas all the other sheets are scheduled to be printed as main sequence sheets 12 by the main printer 10.

In the embodiment described here, the main sequence sheets 12 are printed one after the other with only small inter-sheet gaps, as long as no insert sheet is to be inserted therebetween. However, where an insert sheet 22 is to be inserted, the main printer 10 is left idle for a while so as to leave an empty space on the conveyer 20, where the insert sheet 22 will then be inserted by means of the inserter 16. Consequently, the conveyer 20 may be operated with a constant and uniform speed, and the sheets of the mixed sheet sequence 24 are forwarded to the output unit 18 one after the other and with uniform and small inter-sheet gaps. This permits an efficient finishing processing in the output unit 18.

When the control system 36 recognizes that the job contains insert sheets 22, it controls the insert sheet printer 34 to print the insert sheets 22 timely enough. In the case that the first insert sheet 22 is not one of the first few sheets of the job, the job processing may start without delay with printing the first few main sequent sheets 12 and simultaneously printing the first insert sheet with the relatively slow insert sheet printer 34, so that the first insert sheet will be ready on the tray 28 when it has to be inserted.

When the job contains a plurality of insert sheets 22 with no or only few main sequence sheets 12 intervening therebetween, the insert sheet printer 34 may be controlled to print the insert sheet in advance and “on stock”. The printed insert sheets will be stacked on the tray 28. In the shown embodiment it is necessary, however, that the insert sheets 22 are printed in reverse order so that the insert sheet that is needed first will be the one on top of the stack.

In case that the insert sheets 22 are needed earlier than they can be printed with the insert sheet printer 34, it may be necessary to delay the start of print processing with the main printer 10 or to interrupt the print processing in the main printer. However, if several print jobs are waiting in a print queue, the productivity of the printing system may be enhanced by analysing the print jobs in the print queue in advance, so that insert sheets for a print job may be printed already before the processing of the main sequence sheets of that job actually starts. More precisely, the printing of insert sheets may start as soon as the tray 28 is not needed any more for insert sheets in any one of the preceding print jobs.

In practise, the tray 28 will only be capable of accommodating a stack of a limited number of sheets. It is common practise for known inserters that the feed tray has a stack height sensor producing an overflow signal when the maximum capacity of the tray 28 has been reached. The control system 36 is therefore preferably arranged to receive the overflow signal from the height sensor and to react with stopping the operation of the insert sheet printer 34 until at least one insert sheet has been withdrawn from the tray 28 for being inserted.

The manual feed tray 26 still offers the possibility that insert sheets are supplied manually by the operator. In this way, it is possible for example to process print jobs that require two different types of insert sheets, e.g. sheets of different media types. The insert sheet printer 34 and the inserter 16 will then be controlled such that an insert sheet of a first type is printed by the insert sheet printer 34 and fed via the tray 28 or an insert sheet of a second type is withdrawn from the manual feed tray 26, depending on the job specifications.

In the example shown, the tray 28 receiving the insert sheets from the insert sheet printer 34 is covered by a hood 38 to prevent the operator from inadvertently placing the sheets on the wrong tray, when insert sheets are supplied manually.

FIG. 2 illustrates an example of a possible mode of operation of the printing system shown in FIG. 1. In this simple example, a print job 40 that is submitted to the control system 36 consists for four duplex sheets, i.e. a front cover sheet 42, two body sheets 44 and a back cover sheet 46. The cover sheets 42 and 46 have been shown in dashed lines, which shows that these sheets are scheduled as insert sheets, whereas the body sheets 44 are scheduled as main sequence sheets. The front cover sheet 42 is to receive an image A on the front side and an image B on the back side. The first body sheet 44 is to receive image information for a page “1” on the front side and for a page “2” on the back side. Similarly, the second body sheet is to receive image information for a page “3” on the front side and for a page “4” on the back side. The back cover sheet 46 is to receive an image C on the front side and an image D on the back side.

In this example, the main printer 10 is configured to output the sheets “face-down”, i.e. first body sheet 44 will leave the printer with page “1” facing downwards. Consequently, in order to obtain a collated stack of sheets in the output unit 18, the mixed sheet sequence 24 arriving at the output unit 18 must contain the sheets in the order “first sheet first”. This means that the front cover sheet 42 is the first sheet to reach the output unit 18 with the image A on the bottom side and the image B on the top side. The next sheets to follow are the body sheets 44 in the page order “1”, “2”, “3” and “4”, with odd-numbered pages facing downwards, and the last sheet is to be the back cover sheet 46 with the image C on the bottom side and the image D on the top side. Consequently, in order to obtain the body sheets 44 in the correct order, the main printer 10 has to print at first the sheet with the pages “3” and “4” and then the sheet with the pages “1” and “2”.

Further, it shall be assumed here that the insert sheet printer 34 has enough spare time to print the insert sheets (constituted by the cover sheets 42 and 46) in advance and stack them on the tray 28 before the first of these insert sheets is needed. Then, since the front cover sheet 42 is the first sheet that needs to be inserted, this sheet has to be on top of the stack and consequently must be the last sheet that is printed by the insert sheet printer. This has been illustrated in FIG. 2, where the front cover sheet 42 is shown on top of the back cover sheet 46. Further, since the orientation of the insert sheets is reversed in the inserter 16, the image A must face upwards when the sheet is on the tray 28. Similarly, the back cover sheet 46 (which is printed first) must leave the insert sheet printer 34 with the image C facing upwards.

FIG. 3 shows a modified printing scheme for the case that the main printer 10 is configured to print the sheets in the orientation “face-up” and the mixed sheet sequence 24 is ordered “last sheet first”. Here, the insert sheet printer 34 has to print the front cover sheet 42 first and the back cover sheet 46 second.

FIG. 4 shows an embodiment of a printing system wherein the insert sheet printer 34 is mounted on top of the output unit 18 and arranged to discharge the insert sheets 22 onto the tray 28 in the same direction in which the sheets are withdrawn by the feeder 30 of the inserter 16. Of course, the orientation of the images on the top and bottom sides of the insert sheets 22 has to be adapted appropriately. With this system, it is possible to use the same printing schemes as in FIGS. 2 and 3.

If a sufficient spacings exists between two successive insert sheets 22, it is possible with both embodiments of the printing system to employ an alternative printing scheme where the insert sheets 22 are not stacked on the tray 28 but are printed when they are required. In that case, of course, the insert sheets have to be printed in the order in which they are needed.

In the examples described above, it may be assumed that the insert sheet printer 34, if it is a duplex printer, has two print head assemblies arranged on opposite sides of the sheet transport path inside the printer, so that the images on the top side and on the bottom side of each sheet can be printed simultaneously with the two print head assemblies. FIG. 5 illustrates another embodiment employing an insert sheet printer 34′ which has a sheet reversing mechanism 48 (duplex loop) capable of reversing the orientation of a sheet that has been printed with a print engine 50 and then returning the sheet to the entry side of the print engine for printing an image onto the other side of the sheet. The sheet reversing mechanism 48 may be of a known type and is therefore not described here in greater detail. A switch 52 is provided for directing a printed sheet either into the duplex loop or onto the tray 28. In this case, the print engine 50 needs to have only one print head assembly on one side of the sheet transport path. However, more time is needed for printing a duplex insert sheet. The insert sheets 22 may be printed and discharged onto the tray 28 either “face-up” or “face-down”.

When a simplex insert sheet is to be discharged face-down, the switch is controlled to deflect the sheet towards the tray 28 when it has left the print engine 50. In order to discharge the sheet face-up, it is first reversed in the sheet reversing mechanism 48 and then passed through underneath the print engine 50 once again without being printed, and then it is discharged via the switch 52. In case of a duplex insert sheet, the sheet is always passed through the duplex loop, and the orientation “face-up” or “face-down” is controlled by determining the sequence in which two images for the front side and the back side are printed.

1. A printing system comprising:
at least one main printer arranged to print images onto main sequence sheets that are passed sequentially through the main printer;
an inserter arranged to insert individual sheets as insert sheets into a stream of main sequence sheets that have left the main printer, thereby to form a mixed sheet sequence; and
a conveyer arranged to convey the sheets of the mixed sheet sequence one by one towards an output unit,
characterised in that an insert sheet printer is connected to the inserter for printing the insert sheets and forward them to the inserter.

2. The printing system according to claim 1, wherein the inserter has a feed tray, and the insert sheet printer is arranged to discharge the printed insert sheets onto the feed tray.

3. The printing system according to claim 2, wherein the insert sheet printer is installed on top of the inserter and arranged to discharge the printed insert sheets onto the tray in a direction opposite to a direction in which the insert sheets are fed from the tray into the inserter.

4. The printing system according to claim 2, wherein the insert sheet printer is arranged to discharge the printed insert sheets onto the feed tray in the same direction as a direction in which the insert sheets are fed into the inserter.

5. The printing system according to claim 1, wherein the insert sheet printer is a duplex printer.

6. The printing system according to claim 5, wherein the insert sheet printer has a sheet reversing mechanism.

7. The printing system according to claim 1, wherein the insert sheet printer is controllable to selectively discharge the printed insert sheets towards the feeder in a face-up orientation and a face-down orientation.

8. Printing system according to claim 2, wherein the inserter has at least a second feed tray where insert sheets can be placed manually.

9. Printing system according to claim 1, comprising a common electronic control system for controlling the main printer, the inserter and the insert sheet printer.
